(19) United States
(12) Patent Application Publication
(10) Pub. No.: US 2018/0208109 A1
(43) Pub. Date: Jul. 26, 2018

(54) EL DECORATIVE CAR FOOT MAT

(71) Applicant: SHANGHAI JUN-DA AUTO DECORATION CO., LTD., SHANGHAI (CN)

(72) Inventor: HONGJIE YING, SHANGHAI (CN)

(73) Assignee: SHANGHAI JUN-DA AUTO DECORATION CO., LTD., SHANGHAI (CN)

(21) Appl. No.: 15/714,922

(22) Filed: Sep. 25, 2017

(30) Foreign Application Priority Data
Jan. 20, 2017 (CN) 201720070548.2

(51) Int. Cl. B60Q 3/20; B60N 3/04; B60Q 3/88

(52) U.S. Cl. CPC B60Q 3/20; B60N 3/044; B60Q 2500/00; B60Q 3/88; B60N 3/048

(57) ABSTRACT

Provided is an EL decorative car foot mat, including a front foot mat and a back foot mat, the front foot mat and the back foot mat are respectively installed on front and back base plates in a car, a luminous body is disposed on the front foot mat and the back foot mat, the luminous body is an EL wire or an EL sheet, and the luminous body is powered by an in-vehicle power source. A design of applying a soft neon lamp such as an EL wire or an EL sheet to a foot mat enriches functions of the foot mats, so that while basic requirements of the car foot mat are met, abundant sensual pleasures are increased. The EL decorative car foot mat has advantages of novel design, elegant appearance, dust resistance, dirt resistance, water resistance, abrasion resistance, noise insulation and is safe in use.

### CROSS-REFERENCE TO RELATED APPLICATIONS

The present application is a continuation application of a Chinese utility model No. 201720070548.2, filed on Jan. 20, 2017, which is hereby incorporated by reference in its entireties.

### TECHNICAL FIELD

This disclosure relates to car fittings, and in particular, to an EL decorative car foot mat.

### BACKGROUND

As a car necessity, a car foot mat not only needs to meet basic performance requirements such as dirt resistance, water resistance, easy to care, sound insulation and skid resistance, but the beautiful degree of a product is increasingly concerned. To attract attention of consumers, foot mat manufacturers add all sorts of decorative fittings to foot mats. The decorative fittings can both improve appearance of the foot mats, and bring some additional functions to the foot mats. However, most decorative fittings are beautiful but useless, and cannot meet diversified requirements of users for both pursuing beauty and expecting practical use.

### SUMMARY

According to some embodiments of this disclosure, there is an object to enrich an ornamental value of an existing car foot mat product, and there is provided a car foot mat decorated by using an EL (Electro Luminescence) product, to meet higher requirements of the market for car fittings. By disposing an EL wire or an EL sheet on a foot mat, diversified requirements of users for both pursuing beauty and expecting practical uses are satisfied.

This disclosure is implemented by using the following technical solutions:

An EL decorative car foot mat includes a front foot mat and a back foot mat, the front foot mat and the back foot mat are respectively installed on front and back base plates in a car, a luminous body is disposed on the front foot mat and the back foot mat, the luminous body is an EL wire or an EL sheet, and the luminous body is powered by an in-vehicle power source. The EL decorative foot mat enriches functions of the foot mat, so that while basic requirements of the car foot mat are met, beauty is enhanced. The foot mat may cover an original carpet of the car to the greatest extent, and has functions such as dirt resistance, dust resistance, water resistance, skid resistance, and noise insulation. The foregoing technical solutions are further described as follows: the luminous body is embedded on an outline of the front foot mat and the back foot mat, or on a pattern in the middle of the foot mats, or on a pattern of two sides of the foot mats. The foregoing technical solutions are further described as follows: the EL wire is connected to a control circuit, to implement various dynamic flashing and voice control functions.

The EL decorative foot mat of this disclosure has the following beneficial effects of: 1.

beautiful appearance, and abundant sensual pleasures; and 2. convenient use and installation.

According to an embodiment of this disclosure, there is provided an EL decorative car foot mat, including a front foot mat and a back foot mat, the front foot mat and the back foot mat are respectively installed on front and back base plates in a car, a luminous body is disposed on the front foot mat and the back foot mat, the luminous body is an EL wire or an

EL sheet, and the luminous body is powered by an in-vehicle power source.

According to an embodiment of this disclosure, there is further provided an EL decorative car foot mat, including a front foot mat and a back foot mat, the front foot mat and the back foot mat are respectively installed on front and back base plates in a car, a luminous body is disposed on the front foot mat and the back foot mat, the luminous body is an EL wire or an EL sheet, and the luminous body is powered by an energy storage circuit in the car.

Compared with the prior art, in this embodiment of this disclosure, the EL wire or the EL sheet are disposed on the front foot mat and the back foot mat of the car. After the EL wire or the EL sheet is lightened, a gorgeous light may be presented in the car, and the light can provide lighting to a driver during night driving, and help to improve visual feeling of a user. In addition, the EL wire or the EL sheet has low power consumption, and helps to reduce more power compared with other lighting products. Moreover, light radiated by the EL wire or the EL sheet is soft and not dazzling, and also helps to reduce hidden dangers during night driving. This design helps to meet diversified requirements of users for both pursuing beauty and expecting practical uses.

The luminous body is embedded on an outline of the front foot mat and the back foot mat, or on a pattern in the middle of the foot mats, or on a pattern of two sides of the foot mats. A position arrangement of the luminous body is provided.

The EL wire is connected to a control circuit, to implement various dynamic flashing and voice control functions. This helps to improve visual experiences of a user.

A skirt of soft texture is disposed at one side of the EL wire, and the EL wire is connected to the front foot mat and the back foot mat via the skirt. A connection manner of the EL wire and the foot mats is provided.

The skirt is stitched to the front foot mat and the back foot mat. The stitching and fixing help to prevent the EL wire from disconnecting.

The luminous bodies disposed on the front foot mat and the back foot mat are connected in series or connected in parallel. The serial connection between the luminous bodies can reduce wire stacking.

The luminous bodies disposed on the front foot mat and the back foot mat are controlled by a control circuit in a preset control manner. The preset control manner includes an independent control and a group control. Different control manners enable a user to flexibly choose, according to an actual demand, a luminous body to be lightened.

The control circuit is connected to a light intensity detection circuit. The light intensity detection circuit is configured to detect intensity of ambient light, and send the detected intensity of the ambient light to the control circuit. The control circuit is configured to determine whether the intensity of the ambient light reaches a preset value, and lighten the luminous body when it is determined that the preset value is reached. When the intensity of the ambient light reaches the preset value, the luminous body is lightened automatically, and a service is provided for a user in time. This helps improve use experiences of the user.

The energy storage circuit includes: an energy receiving module, an energy conversion module and an energy output module. The energy receiving module is configured to receive solar energy. The energy conversion module is configured to convert the received solar energy to electric energy. The energy output module is configured to convert the electric energy to a preset supply power voltage, and output the voltage to the luminous body. By using the energy receiving module to receive solar energy, and converting the solar energy to electric energy, to charge the luminous body, the electric energy is reduced.

### BRIEF DESCRIPTION OF THE DRAWINGS

Exemplary descriptions are performed in one or more embodiments by using figures in the corresponding accompanying drawings, and these exemplary descriptions do not constitute a limitation to the embodiments. Elements with same reference numbers in the accompanying drawings indicate similar elements. Unless particularly stated, the figures in the accompanying drawings do not constitute a proportion limitation.

FIG. 1 is a schematic view of an overall structure of an EL decorative car foot mat according to a first embodiment of this disclosure;

FIG. 2 is a circuit diagram of the EL decorative car foot mat according to the first embodiment of this disclosure;

FIG. 3 is a schematic view of a skirt according to a second embodiment of this disclosure;

FIG. 4 is a schematic diagram of a connection of an EL wire, a voice control drive apparatus and an in-vehicle power source according to the second embodiment of this disclosure;

FIG. 5 is a schematic diagram of a connection of EL wires, a control circuit and an in-vehicle power source according to a third embodiment of this disclosure;

FIG. 6 is a schematic diagram of a connection of a control circuit and a light intensity detection circuit according to a fourth embodiment of this disclosure; and

FIG. 7 is schematic structural diagram of an energy storage circuit according to a fifth embodiment of this disclosure.

### DETAILED DESCRIPTION

To make the objective, the technical solutions, and advantages of this disclosure clearer, the following further describes some embodiments of this disclosure in detail with reference to the accompanying drawings and embodiments. It should be understood that, specific embodiments described herein are only used to explain this disclosure, rather than limiting this disclosure.

A first embodiment of this disclosure relates to an EL decorative car foot mat.

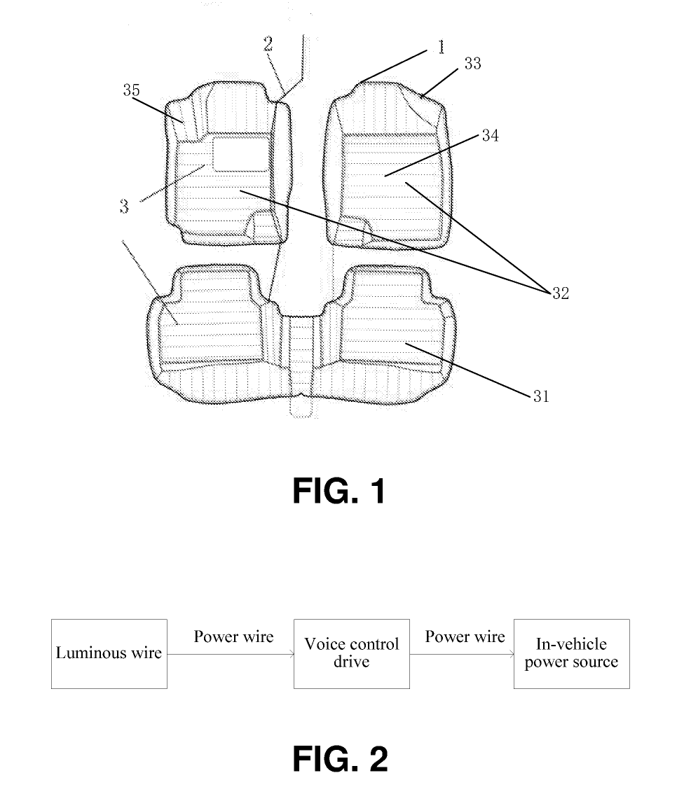

FIG. 1 and FIG. 2 show a schematic view of an overall structure and a circuit diagram of the EL decorative car foot mat, an EL wire path 1, a power connection wire 2 and a foot mat 3. The EL decorative foot mat uses an EL product as a design style applied to the car foot mat.

As an upgraded version, the improved car foot mat of this disclosure is developed based on a conventional foot mat. A feature of the foot mat lies in that: when night falls, an EL power source may be turned on to present a gorgeous light in a car, an EL wire used for decorating the foot mat uses an electro luminescence principle, and has power consumption 75% of other similar products. When in use, a working current is extremely small, and a human body is not in danger. The product produces no environmental pollution when being used and discarded. The EL wire used for decorating the foot mat is soft and lighting, and not drizzling, and causes no hidden danger during night driving. The EL wire used for decorating the foot mat has features such as being soft, foldable, and knotted, tailored, and spliced at will, and does not affect lighting performance. The EL wire may glow in multiple colors at full 360 degrees, and may be in a single color or combined in multiple colors. An ultrathin and flat skirt at one side of the EL wire is stitched and fixed with fabrics, and is difficult to take away. The EL wire used for decorating the foot mat implements various dynamic flashing and voice control functions according to circuit control and matching. To be more adapted to decorations of car seat cover products, details of the EL wire product are improved. By using the EL wire with a skirt, and designs of an outer cover of a soft material and an ultrathin skirt, the requirement of the soft material for the softness of the EL wire is more met. Problems such as raised rims and excessively large stitching gaps that appear when the skirt rim and the seat cover material are stitched together are reduced, and the exquisiteness of the seat cover decorations is increased. The whole seat cover is mounted in the car, and the seat covers are connected in series by using a snap fastener, and then connected to a voice control drive apparatus. Finally, a method such as a car cigarette lighter or a USB interface is used as a terminal car connection manner.

A second embodiment of this disclosure relates to an EL decorative car foot mat. As shown in FIG. 1, the foot mat 3 includes a front foot mat 31 and a back foot mat 32, a luminous body is disposed on the foot mat 3, and the luminous body may be an EL wire or an EL sheet. That the luminous body is an EL wire is used as an example for description in this embodiment.

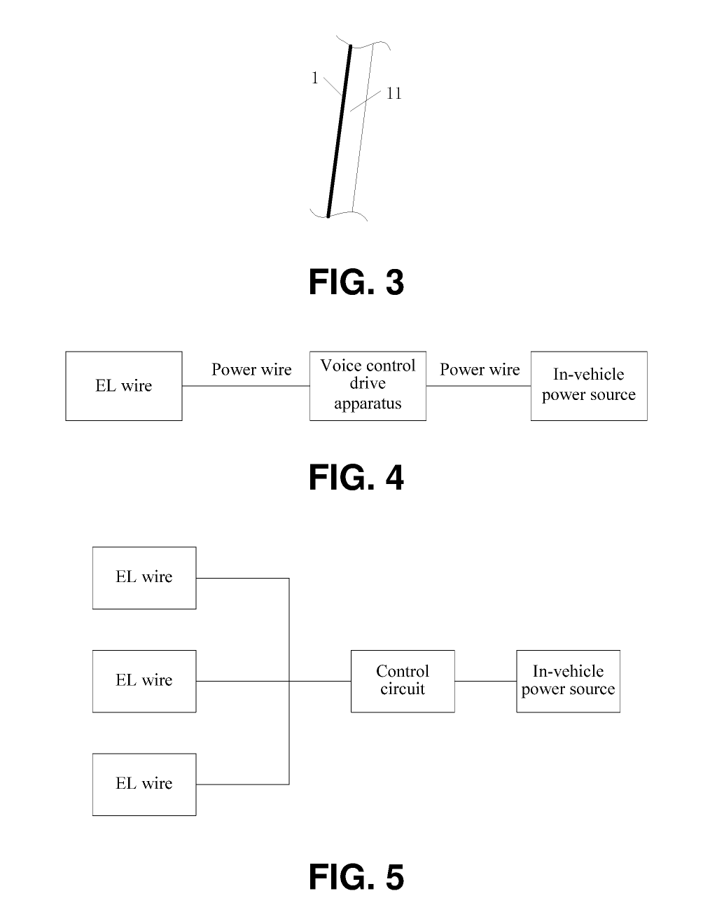

Specifically, the EL wire 1 (namely, an EL wire path 1 in the first embodiment) may be embedded on an outline 33 of the foot mat 3, or a pattern 34 in the middle of the foot mat, or a pattern 35 on two sides of the foot mat. An ultrathin skirt 11 (as shown in FIG. 3) is disposed at one side of the EL wire 1, and the EL wire 1 is connected to the foot mat 3 through the skirt 11. In this embodiment, the skirt 11 may be stitched to the foot mat 3, but this embodiment is not limited thereto. In actual applications, the skirt 11 and the foot mat 3 may be connected in another manner. The skirt 11 is flat, and is made of a material of soft texture, and usually has a width of a fixed value. Making the skirt 11 by choosing a material of soft texture helps to prevent problems such as raised rims and excessively large stitching gaps that appear when the skirt 11 and the foot mat 3 are stitched together, and increase the exquisiteness of the foot mat decorations.

In this embodiment, the EL wires 1 disposed on the foot mats 3 are connected in series by using a snap fastener, and are connected to a control circuit. The control circuit may control ON/OFF of the EL wire 1. In addition, the control circuit further includes a voice control drive apparatus. The EL wires 1 connected in series by using the snap fastener, and are connected to the voice control drive apparatus, to implement a voice control function. With the connection in series, there is only one wire to connect the control circuit with a power source, which helps to reduce wire stacking. In this embodiment, the in-vehicle power source supplies power to the luminous body. FIG. 4 shows a schematic diagram of a connection of an EL wire, a voice control drive apparatus and an in-vehicle power source. The drive apparatus is connected to the in-vehicle power source by using a cigarette lighter or a USB interface. A power wire in FIG. 4 is also referred to as a power connection wire, that is, the power connection wire indicated by a reference number 2 in FIG. 1.

When night falls, the control circuit may be used to turn on the EL wire, and the EL wire may present a gorgeous light in the car. The EL wire uses an electro luminescence principle, and has power consumption 75% of other similar products. When in use, a working current is extremely small, and a human body safety is not threatened. The EL wire produces no environmental pollution when being used and discarded. In addition, the light radiated by the EL wire used for decorating the foot mat is soft and not drizzling to human eyes, and causes no hidden danger during night driving. Moreover, the EL wire used for decorating the foot mat has features such as being soft, foldable, and knotted, tailored, and spliced at will, and does not affect lighting performance. The EL wire may glow in multiple colors at full 360 degrees, and may be in single colors or combined in multiple colors. An ultrathin and flat skirt at one side of the EL wire is stitched and fixed with foot mat materials, and is difficult to take away. The EL wire used for decorating the foot mat may implement various dynamic flashing and voice control functions according to circuit control and matching.

A third embodiment of this disclosure relates to an EL decorative car foot mat. The third embodiment is substantially the same as the second embodiment, and a main difference lies in that: in the second embodiment, the luminous bodies disposed on the foot mats are connected in series, but in the third embodiment, the luminous bodies disposed on the foot mats are connected in parallel.

As shown in FIG. 5, the luminous bodies disposed on the foot mats are connected in parallel and then connected to a control circuit, and the control circuit is connected to an in-vehicle power source. The luminous bodies are connected in parallel, so that the luminous bodies may be free from affecting each other. When one luminous body is damaged or needs to be repaired, normal use of other luminous bodies is not affected, and later maintenance is more facilitated.

It should be noted that, in actual applications, the control circuit may control the luminous body in a preset control manner. The preset control manner includes an independent control and a group control. The independent control means that the control circuit independently controls a luminous body on each foot mat. In this case, each luminous body may form a branch, and when a luminous body needs to be controlled, a branch of the luminous body is conducted, that is, the branch of the luminous body is connected to the control circuit, so that the control circuit may control the luminous body. The group control means the luminous bodies on the foot mats are grouped in advance, and then each group of luminous bodies is controlled by the control circuit. In this case, luminous bodies in one group may form a branch, and when a group of luminous bodies need to be controlled, the branch of the group of luminous bodies is conducted, that is, the branch of the group of luminous bodies is connected to the control circuit, so that the control circuit may control the group of luminous bodies. With this manner, a user enables to flexibly choose, according to an actual demand, the number of luminous bodies that need to be controlled, instead of operating all luminous bodies each time.

The EL wire or the EL sheet has low power consumption, and produces no heat radiation during working, so that the foot mat temperature is not raised, and no discomfort is caused to the user. Therefore, choosing the EL wire or the EL sheet as the luminous body can not only improve visual feeling of the user, but also help to save energy and improve use experiences of the user.

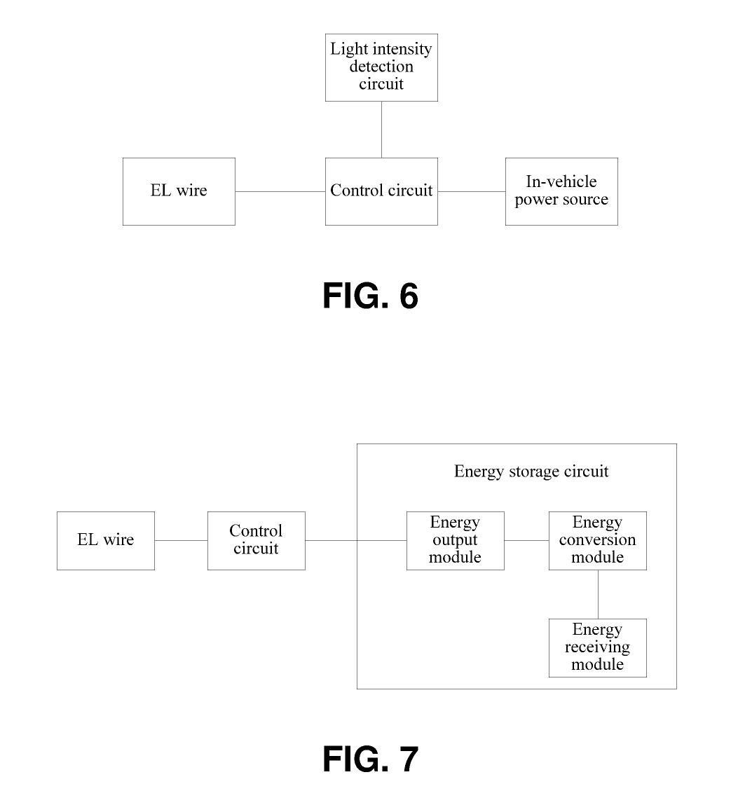

A fourth embodiment of the present disclosure relates to an EL decorative car foot mat. The fourth embodiment is a further improvement made based on the second embodiment, and the main improvement lies in: in the fourth embodiment, the control circuit is further connected to a light intensity detection circuit (as shown in FIG. 6).

Specifically, the light intensity detection circuit may be configured to detect intensity of ambient light, and send the detected intensity of the ambient light to the control circuit. In actual applications, the light intensity detection circuit may be configured to detect the intensity of the ambient light in real time or periodically; or a preset time range may be set, and only within the preset time range, the light intensity detection circuit is enabled to detect the intensity of the ambient light. For example, a preset time range of 6:00 pm to 6:00 am is set, and when time enters the range of 6:00 pm to 6:00 am, the light intensity detection circuit starts to detect the intensity of the ambient light.

When receiving the intensity of the ambient light, the control circuit may determine whether the intensity of the ambient light reaches a preset value, and lighten (turn on) the luminous body when determining that the preset value is reached. The preset value may be set by the user according to a user demand.

When the intensity of the ambient light reaches the preset value, the luminous body is lightened automatically, and a service is provided to the user in time. This helps to improve use experiences of the user.

A fifth embodiment of this disclosure relates to an EL decorative car foot mat. This embodiment is substantially the same as the first embodiment, and the main difference lies in that: in the first embodiment, the in-vehicle power source supplies power to the luminous body; but in the fifth embodiment, an energy storage circuit in a car supplies power to the luminous body.

Specifically, as shown in FIG. 7, the energy storage circuit includes an energy receiving module, an energy conversion module and an energy output module. The energy receiving module may be disposed outside of the car, and is configured to receive solar energy. The energy conversion module is configured to convert the received solar energy to electric energy. The energy output module is configured to convert the electric energy to a preset supply power voltage, and output the voltage to the luminous body. The preset supply power voltage may be set according to a voltage required by the luminous body. By using the energy receiving module to receive solar energy, and converting the solar energy to electric energy, to charge the luminous body, the electric energy is reduced.

A person of ordinary skill in the art may understand that, the foregoing embodiments are specific embodiments for implementing this application. In actual applications, various changes may be made to the embodiments in forms and details without departing from the spirit and scope of this disclosure.

What is claimed is:

1. An EL decorative car foot mat, comprising a front foot mat and a back foot mat, wherein the front foot mat and the back foot mat are respectively installed on front and back base plates in a car, a luminous body is disposed on the front foot mat and the back foot mat, the luminous body is an EL wire or an EL sheet, and the luminous body is powered by an in-vehicle power source.

2. The EL decorative car foot mat according to claim 1, wherein the luminous body is embedded on an outline of the front foot mat and the back foot mat, or on a pattern in the middle of the foot mats, or on a pattern of two sides of the foot mats.

3. The EL decorative car foot mat according to claim 1, wherein the EL wire is connected to a control circuit, to implement various dynamic flashing and voice control functions.

4. The EL decorative car foot mat according to claim 3, wherein the control circuit comprises a voice control drive apparatus; and
the EL wires disposed on the front foot mat and the back foot mat are connected in series by using a snap fastener, and are connected to the voice control drive apparatus, and the voice control drive apparatus is connected to the in-vehicle power source by using a cigarette lighter or a USB interface.

5. The EL decorative car foot mat according to claim 1, wherein a skirt of soft texture is disposed on one side of the EL wire, and the EL wire is connected to the front foot mat and the back foot mat by using the skirt.

6. The EL decorative car foot mat according to claim 5, wherein the skirt is stitched to the front foot mat and the back foot mat.

7. The EL decorative car foot mat according to claim 1, wherein the luminous bodies disposed on the front foot mat and the back foot mat are connected in parallel.

8. The EL decorative car foot mat according to claim 1, wherein the luminous bodies disposed on the front foot mat and the back foot mat are controlled by a control circuit in a preset control manner.

9. The EL decorative car foot mat according to claim 8, wherein the preset control manner comprises an independent control and a group control.

10. The EL decorative car foot mat according to claim 3, wherein the control circuit is connected to a light intensity detection circuit;
the light intensity detection circuit is configured to detect intensity of ambient light, and send the detected intensity of the ambient light to the control circuit; and
the control circuit is configured to determine whether the intensity of the ambient light reaches a preset value, and lighten the luminous body when it is determined that the preset value is reached.

11. An EL decorative car foot mat, comprising a front foot mat and a back foot mat, wherein the front foot mat and the back foot mat are respectively installed on front and back base plates in a car, a luminous body is disposed on the front foot mat and the back foot mat, the luminous body is an EL wire or an EL sheet, and the luminous body is powered by an energy storage circuit in the car.

12. The EL decorative car foot mat according to claim 11, wherein the energy storage circuit comprises: an energy receiving module, an energy conversion module, and an energy output module, wherein
the energy receiving module is configured to receive solar energy;
the energy conversion module is configured to convert the received solar energy to electric energy; and
the energy output module is configured to convert the electric energy to a preset supply power voltage, and output the voltage to the luminous body.
